(19) United States
(12) Patent Application Publication
(10) Pub. No.: US 2018/0318707 A1
(43) Pub. Date: Nov. 8, 2018

(54) METHOD FOR EXECUTING COMPUTER GAME USING VEHICLE LICENSE PLATE NUMBERS

(71) Applicant: Dmitry Alekseevich MORDASHOV, Moscow (RU)

(72) Inventors: Dmitry Alekseevich MORDASHOV, Moscow (RU); Georgii Arkadjevich VARTANIAN, Moscow (RU)

(21) Appl. No.: 15/983,926

(22) Filed: May 18, 2018

Related U.S. Application Data
(63) Continuation-in-part of application No. 15/746,689.

(51) Int. Cl. A63F 13/35; G06K 9/32; G06K 9/00; A63F 13/216

(52) U.S. Cl. CPC A63F 13/35; A63F 13/216; G06K 9/00664; G06K 9/3258

(57) ABSTRACT

A method and a server for executing a computer game using vehicle license plate numbers are provided. Prior to starting the computer game, respective playing sets of one or more vehicle license plate images for at least two players are received and at least two matching opponents are selected from the at least two players. A respective playing number from the respective playing set is received from the at least two matching opponents. A point-value for each one of the at least two matching opponents is calculated based on the respective playing number, the point-value being for the at least one game round. For each opponent, the point-value is aggregated to a cumulative point-value for the opponent. The winner of the computer game is determined by the server by selecting a winning player with a highest value of the cumulative point-values.

### CROSS-REFERENCE

The present application is a continuation-in-part of U.S. patent application Ser. No. 15/746,689, entitled COMPUTER GAMING METHOD USING VEHICLE REGISTRATION NUMBERS”, which is a National Phase Entry of International Patent Application no. PCT/RU2015/000463, filed on Jul. 22, 2015, entitled COMPUTER GAMING METHOD USING VEHICLE REGISTRATION NUMBERS”. Both of these applications are incorporated by reference herein in its entirety.

### FIELD OF TECHNOLOGY

The present technology relates to multiplayer computer games played on mobile devices.

### BACKGROUND

The computer gaming industry is currently on the rise. We see dozens of game applications for various platforms, such as smartphones, PCs, game consoles, etc., being released on a daily basis.

There are conventional technologies, namely tabletop card or board games for several players using vehicle license plate numbers. Such games are not very player-friendly, since they require some special equipment and the players have to be close to each other, e.g. in the same room (or around the same table), which detracts from the gaming process.

### SUMMARY OF THE TECHNOLOGY

The objective of the present technology is to overcome the drawbacks of the existing conventional solutions.

This gaming method allows to use vehicle license plate numbers to play, thus combining on-line and off-line activities, which results in a more engaging and versatile gaming process.

In accordance with a first broad aspect of the present technology, there is provided a method for executing a computer game using vehicle license plate numbers is provided. The method is executable on a computing apparatus accessible by a plurality of user devices via a communication network. In at least embodiment, the method comprises: receiving, by the computing apparatus, respective playing sets of one or more vehicle license plate images for at least two players prior to starting the computer game; selecting from the at least two players, at least two matching opponents; running at least one game round, the running including at least: receiving from the at least two matching opponents a respective playing number from the respective playing set the playing numbers being a textual representation of a selected one of the one or more vehicle license plate images, and calculating a point-value for each one of the at least two matching opponents based on the respective playing number, the point-value being for the at least one game round; aggregating for each opponent the point-value to a cumulative point-values for the opponent, the cumulative point-value being a total of the point-value for the at least one game round and all previously played rounds for the at least two opponents; and determining the winner of the computer game by selecting a winning player with a highest value of the cumulative point-values.

In at least one embodiment, the selecting of the at least two matching opponents may comprise analyzing the plurality of users based on an average strength of the respective playing sets.

In at least one embodiment, a given playing set may be generated, by the user device using a camera integrated into the user device, the playing set being generated by taking a photo of a license plate, the photo having been processed by the user device and stored as an image and corresponding letter-and-digit data as playing numbers in an account associated with a given user associated with the user device.

The letter-and-digit data may be used as the playing numbers and the image may be used for verification of the playing numbers.

After the selecting from the at least two players, at least two matching, the method may further comprise adjusting a strength of their respective playing sets by at least adding or removing playing numbers.

The method may further comprise generating a random order for the at least two opponents to play.

The method may further comprise assigning to each player a pre-determined time interval to play a turn and wherein the method further comprises, in response to the pre-determined time interval expiring without the user playing the turn, automatically playing the turn for the user.

The calculating a point-value may comprise comparing playing numbers of the at least two opponents by: for the given playing number: extracting at least one lexeme from each playing number based on lexical analysis; determining the total number of points gained by comparing all the extracted lexemes for each pair of playing numbers based on pre-set rules, wherein each rule define the number of points gained based on the analysis of each lexeme type.

The calculating a point-value may comprise comparing playing numbers of the at least two opponents by, for the given playing number having a plurality of symbols, comparing the plurality of symbols, in a symbol by symbol manner, using their corresponding numerical values, to another plurality of symbols of a playing number of another user, wherein if one plurality of symbols is shorter than another plurality of symbols, the missing positions are filled with a pre-determined symbol for the purposes of the comparison; determining the number of points gained by each playing number based on the number of higher-valued and lower-valued symbols.

The number of points gained by each player at the end of the game may be determined using at least one of: result of the given game for the player, the result being one of a victory, a loss, and a draw, player's rating, game type, the strength of playing numbers in the given playing set, the number of victories in a row, the score difference between the players, the number of real playing numbers played during the game.

Determining of points gained by players further may comprise analyzing geolocation information. For a new round of the game, playing sets of participating players based on the results of the game round just finished may be generated.

In accordance with a first broad aspect of the present technology, there is provided a server for executing a computer game using vehicle license plate numbers. In at least one embodiment, the server has a processor configured to: receive, by the computing apparatus, respective playing sets of one or more vehicle license plate images for at least two players prior to starting the computer game; select, from the at least two players, at least two matching opponents; run at least one game round, the running including at least: receiving from the at least two matching opponents a respective playing number from the respective playing set the playing numbers being a textual representation of a selected one of the one or more vehicle license plate images; calculating a point-value for each one of the at least two matching opponents based on the respective playing number, the point-value being for the at least one game round; aggregate for each opponent the point-value to a cumulative point-value for the opponent, the cumulative point-value being a total of the point-value for the at least one game round and all previously played rounds for the at least two opponents; and determine the winner of the computer game by selecting a winning player with a highest value of the cumulative point-values.

In at least one embodiment, determining the winner by the processor further comprises analyzing geolocation information. Determining the winner by the processor may further comprise taking into account an area or a perimeter of a polygon formed by locations of the playing numbers played by the at least two opponents.

In at least one embodiment, the processor may be further configured to take into account a distance between locations of the playing numbers played by the at least two opponents. The processor may be further configured to store the geolocation information of the at least one player and to link the geolocation information to a corresponding playing number when a photo of the vehicle license plate number is taken by a camera. The geolocation information may be determined through at least one of: GPS, A-GPS satellite navigation systems, GLONASS system, and a base station triangulation.

A method for a computer game using vehicle license plate numbers is provided. Prior to starting the game, players prepare their playing sets of one or more vehicle license plate numbers using a camera integrated into a mobile device that shoots license plate numbers and stores them along with their corresponding letter-and-digit data as playing numbers in the account; then, opponents are matched and the game starts, running for at least one round, during which players do their turns by choosing one playing number from their respective playing sets, in players' order; then, the number of points gained by each player in the given round is calculated, and the players' point totals scored over the entire series of game rounds are compared to determine the winner of the given game.

In an exemplary embodiment, depicted in FIG. 8, the player shoots a vehicle license plate number 801 with a mobile device camera and inputs its letter-and-digit combination 802. Then, this information is stored as a playing number in the playing set associated with the player's account 803.

In an exemplary embodiment, each player has limited time to make their turn, and if it runs out, the turn is made automatically.

In an exemplary embodiment, the player to make the first turn in the game is chosen randomly.

In an exemplary embodiment, players to make the first turn in each round are chosen in the players' order.

In an exemplary embodiment, opponents are matched based on the average strength of their playing sets.

In an exemplary embodiment, opponents are matched based on their current geolocations.

In an exemplary embodiment, when opponents are matched based on their current geolocations, their countries and cities are determined, so that opponents can be matched both in the same city and in different cities, both in the same country or in different countries. In an exemplary embodiment, the choice of the country may be based on the player's rating, previous opponents' countries, or other gameplay settings.

In an exemplary embodiment, opponents are matched so that the current geolocation of the potential opponent is inside a virtual polygon formed by the geolocations of the playing numbers in the player's playing set.

In an exemplary embodiment, point totals gained by players at the end of the game are determined using at least one of the following parameters: result of the given game for the player (victory, loss, draw), player's rating, game type, the strength of their playing numbers, the number of victories in a row, the score difference between the players, the number of real playing numbers played during the game, the player's current geolocation, and playing number geolocations.

In an exemplary embodiment, after the opponents have been matched, their strength is leveled by adding/removing playing numbers in their playing sets. For instance, if a playing set contains ten playing numbers, three more leveling numbers may be added to it.

In an exemplary embodiment, when playing set strength is being leveled, playing numbers added for that purpose will have random geolocations.

In an exemplary embodiment, when playing set strength is being leveled, playing numbers added for that purpose will have pre-set geolocations.

A method for comparing playing numbers comprises the following steps:

Receiving at least two playing numbers;

Comparing the playing numbers symbol by symbol using their corresponding numerical values with a CPU, wherein if one number is shorter than the other, the missing positions are filled with Vs for the purposes of the comparison;

Determining the number of points gained by each playing number with a CPU based on the number of higher-valued and lower-valued symbols.

In exemplary embodiments, 0<=V<10.

In exemplary embodiments, the missing positions (V) are set to a pre-determined symbol, such as zeroes or ones, or Zs, or nines.

In at least one embodiment, the server for executing a computer game using vehicle license plate numbers has a processor is configured to execute the following steps, as depicted in FIG. 6: receiving a new game request from the player 601; matching the player with an opponent 602 using the pre-set criteria; choosing the player to go first 603; starting the game 604 that would last for at least one round 605; sending this information to all other players participating in the current game; receiving information about playing numbers chosen to be played this turn 606 from each player in players' order, starting from the first player, and then determining the number of points 607 scored by each playing number in the current round by comparing the numbers played by players symbol by symbol; determining the winner 608 of the current game based on point totals gained by each player over the entire series of game rounds; determining the point totals 609 gained by each player during the game using at least one of the following parameters: result of the given game for the player (victory, loss, draw), player's rating, game type, the strength of playing numbers, the number of victories in a row, the score difference between the players, the number of real playing numbers played during the game, and/or geolocations of numbers played during the game, the game statistics are updated with respect to the points total determined in the previous step.

In at least one embodiment, the server is configured to perform the following steps: receiving a new game request from the player; matching the player with an opponent using the pre-set criteria; choosing the player to go first and sending this information to all other players participating in the current game; starting the game that would last for at least one round; receiving information about playing numbers chosen to be played this turn from each player in players' order, starting from the first player, and then determining the number of points scored by each playing number in the current round by comparing the numbers played by players symbol by symbol; determining the winner of the current game based on point totals gained by each player over the entire series of game rounds; determining the point totals gained by each player during the game using at least one of the following parameters: result of the given game for the player (victory, loss, draw), player's rating, game type, the strength of playing numbers, the number of victories in a row, the score difference between the players, and/or the number of real playing numbers played during the game, the game statistics are updated with respect to the points total determined in the previous step.

In an exemplary embodiment, when determining the winner, the computer system takes into account the geolocations of numbers that have been played during the game.

In an exemplary embodiment, when determining the winner, the computer system takes into account the area or perimeter of the polygon formed by the locations of playing numbers played by the opponents.

In an exemplary embodiment, when determining the winner, the computer system takes into account the distance between the geolocations of playing numbers played by the opponents.

A mobile device with a computer program that performs the following steps: shooting a vehicle license plate number with a camera, inputting its corresponding letter-and-digit data with an input device, and sending a request to add the number to the player's playing set to the computer system; sending a new game request to the computer system; receiving opponent information from the computer system; receiving a turn alert from a remote system; performing a turn by selecting a playing number from the playing set and sending it to the computer system; receiving the opponent's turn information from the computer system; receiving the information on points gained by each player in the given round from the computer system; receiving the information on point totals of each player that have participated in the current game and the winner, after the last round is over; updating the game statistics; and displaying the information about the winner of the current game and the updated game statistics.

In an exemplary embodiment, when a vehicle license plate number is shot with a mobile device, the playing number is associated with the user's geolocation that is stored alongside it.

In an exemplary embodiment, geolocation is determined by the mobile device through GPS and/or A-GPS satellite navigation systems, and/or GLONASS system, and/or base station triangulation.

### BRIEF DESCRIPTION OF THE DRAWINGS

Throughout the description of the technology, reference will be made to the drawings of which:

FIG. 1 depicts a schematic diagram of a system for executing a computer game using vehicle license plate numbers in accordance with non-limiting embodiments of the present technology.

FIG. 2 depicts a schematic diagram of a mobile device in accordance with non-limiting embodiments of the present technology.

FIG. 3 depicts a block diagram of a flow chart of a method for executing a computer game using vehicle license plate numbers in accordance with non-limiting embodiments of the present technology.

FIG. 4 depicts a block diagram of a flow chart of method of playing number comparison in accordance with non-limiting embodiments of the present technology.

FIG. 5 depicts a substitution table containing correlations between each letter and number in accordance with non-limiting embodiments of the present technology.

FIG. 6 depicts a block diagram of a flow chart of a method for executing a computer game using vehicle license plate numbers in accordance with non-limiting embodiments of the present technology.

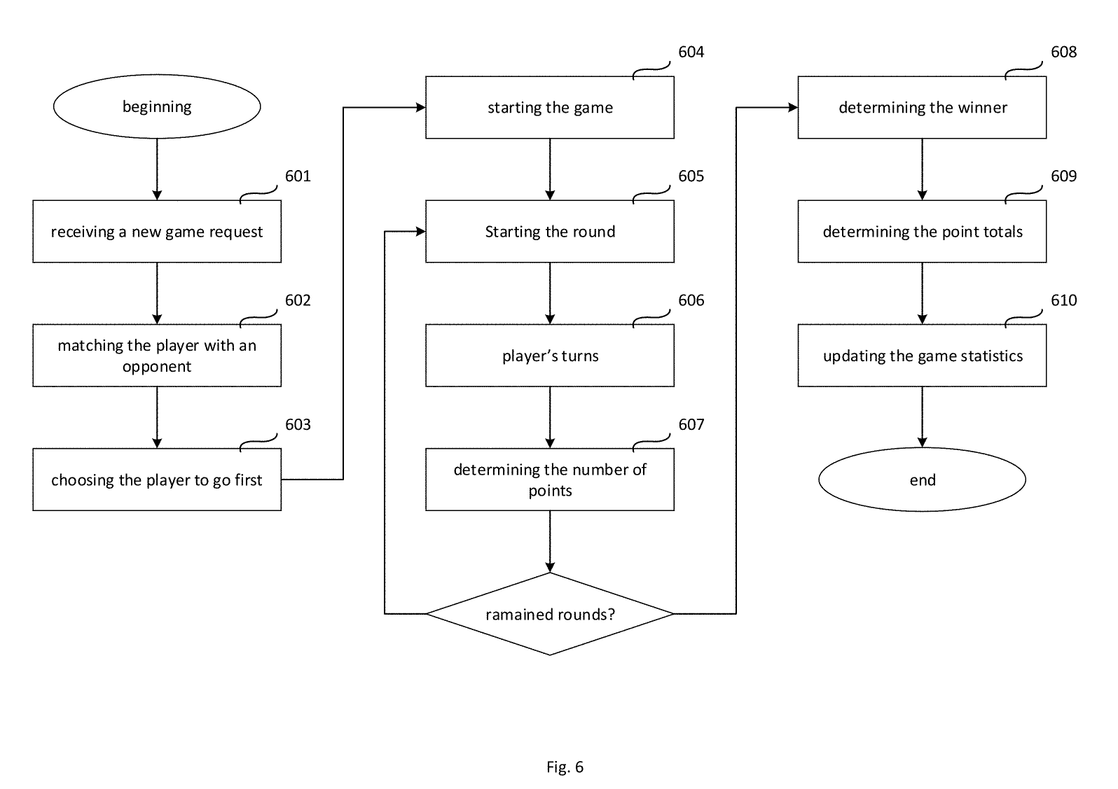

FIG. 7 depicts comparing playing numbers symbol by symbol and substituting missing symbol with a pre-defined value, in accordance with non-limiting embodiments of the present technology.

FIG. 8 depicts a block diagram of a flow chart of a method for executing a computer game using vehicle license plate numbers in accordance with non-limiting embodiments of the present technology.

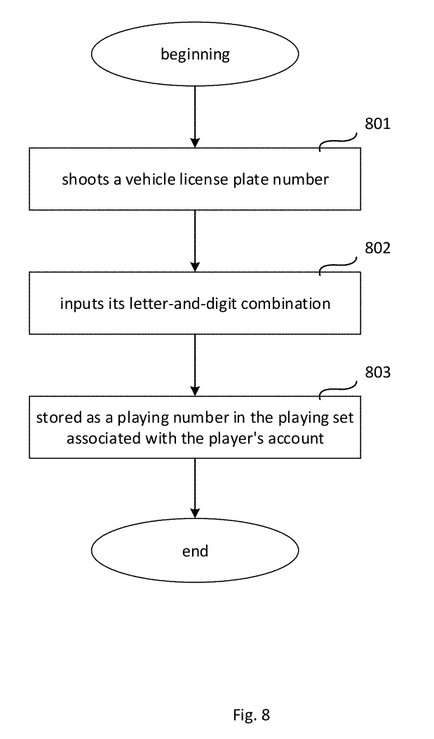

FIG. 9 depicts a schematic diagram of a means for completing a playing set on a mobile device in accordance with non-limiting embodiments of the present technology.

### DETAILED DESCRIPTION OF THE NON-LIMITING EMBODIMENTS

The present technology may be implemented both as hardware (a computer, a computer system, etc.) and as software executed on the hardware described above.

The present technology may be implemented on a distributed computer system.

Below is the list of terms used in the present disclosure along with their definitions:

Round is a series of turns made by players in players' order during the game.

Geolocation is geographical location of a particular object and its geographical relations (distance, direction, etc.) to other objects.

Distributed computer system is a set of independent computers (computer devices) connected to each other via a computer network so as to make up a single system.

Command processing device is an electronic unit or an integral circuit (microprocessor) that performs machine-readable instructions (programs).

The command processing device reads and performs machine-readable instructions (programs) received from one or more data storage devices. Data storage devices include, but are not limited to, hard-disk drives (HDD), flash drives, read-only memory (ROM), solid-state drives (SSD), etc.

Program is a set of instructions designed to be performed by a computer control device or a command processing device.

Units of a distributed system may be connected to each other via both wired and wireless networks.

Syntactic analysis, or parsing, is the process of analyzing ated to each other via both wired and wireless networks.ssing device.more data storage devices. Data storage devices include, but esent technology.ying number from the playing s in a parsing tree. This type of analysis is usually applied together with lexical analysis.

Lexical analysis, or tokenization, is the process of converting a sequence of characters (such as in a computer program or web page) into a sequence of tokens (strings but esent technology.ying number from the playing s in a paases, the terms “lexeme” and “token” are treated equally. However, more sophisticated tokenizers may additionally classify lexemes into various types, such as identifiers, operators, parts of speech, etc.

The game includes at least the following stages:

a player matching stage;

a playing set generation stage;

at least one game round stage;

a game results determining stage, in which the results over a series of game rounds are tallied.

A playing set comprises data used during the game, particularly, a set of playing numbers (e.g. in letter-and-digit format) and their parameters (e.g. playing number geolocation data).

A playing number is a sequence of letters and digits described by pre-defined rules.

For instance, a playing number may look as follows: «or instance, a playing number ma («(r insta) or «orinstance, a playing number may look as fol («(orinsta).

In an exemplary embodiment, before the game is started (i.e. before the first game round), each player generates and completes their own set of playing numbers, in case there are not enough numbers, wherein the playing set is stored in the player's account.

In another exemplary embodiment, a playing set may contain a pre-defined number of playing numbers, e.g. from K₁ to K₂ numbers.

For instance, the lower limit K₁ may be 9, the upper limit K₂ may be 999, while the current number of playing numbers in a given playing set may be 216. These constants, K₁ and K₂, do not affect the subject matter of the technology.

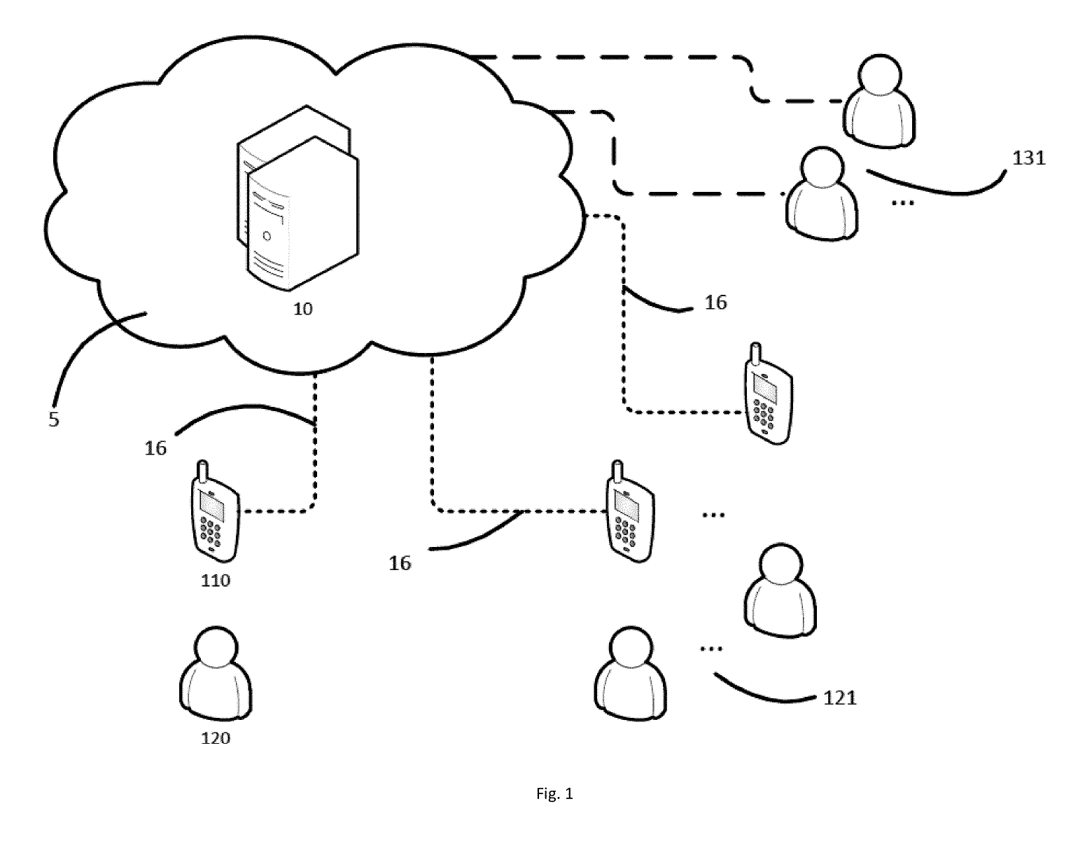

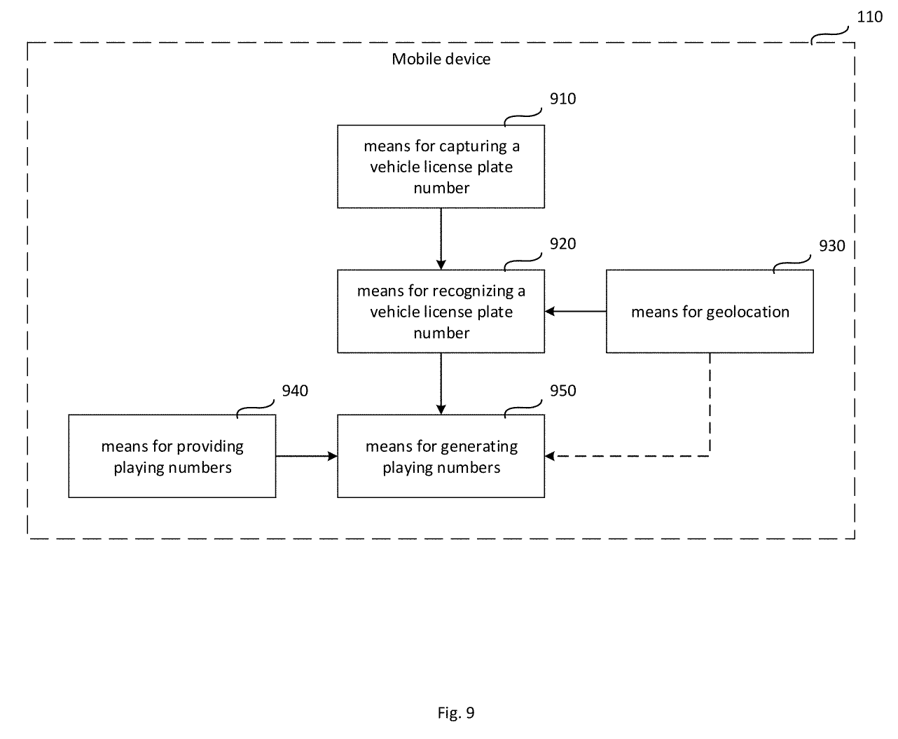

In an exemplary embodiment, to complete a playing set, playing numbers are captured by means for completing a playing set (see FIG. 9) on a mobile device 110 (see FIG. 1), wherein the means for completing a playing set comprise:

a means for capturing playing numbers 910;

a means for recognizing a playing number 920;

a means for geolocation 930;

a means for providing playing numbers 940;

a means for generating playing numbers 950.

To complete a playing set with playing numbers, at least the following steps have to be performed:
capturing a vehicle license plate number with the means for capturing playing numbers 910;
recognizing the captured vehicle license plate number with the a means for recognizing a playing number 920;
completing the playing set based on the information obtained during previous steps with the means for generating playing numbers 950;
storing the playing set in the player's account 120 in the computer system 5.

In another exemplary embodiment, to capture a vehicle license plate number, one has to at least:
capture a photo of the vehicle license plate number with the camera, camcoder, etc. (including ones that are integrated into the mobile device 110);
record some audio, e.g. the player's 120 speech, about the vehicle license plate number with a microphone (including one that is integrated into the mobile device 110); or
input the vehicle license plate number (its letter-and-digit combination) using the mobile device 110 sensor screen, stylus, etc.

In yet another exemplary embodiment, the captured vehicle license plate number is recognized using the recognition means 920 on the mobile device 110. To recognize a captured vehicle license plate number, the recognition means 920 may use computer vision algorithms that are known in the art (including, for example, those described in An Evaluation of License Plate Recognition Algorithms, Hadi Sharifi Kolour, Asadollah Shahbahrami, Department of Information Technology University of Guilan, Rasht, Iran, International Journal of Digital Information and Wireless Communications (IJDIWC) 1(1): 247-253, The Society of Digital Information and Wireless Communications, 2011(ISSN 2225-658X)), which are capable of recognizing symbols (letters and digits) displayed on the license plate. To recognize audio, the recognition means may use speech recognition algorithms

For instance, the player 120 took a picture of the license plate number of a vehicle parked nearby with their mobile phone 110. The picture from the camera 910 of the mobile phone 110 is processed with the recognition means 920, which provides the license plate number in text format.

In yet another exemplary embodiment, the picture of the vehicle license plate number taken with a camera is sent to the computer system 5, which, using conventional computer vision algorithms, recognizes symbols on the pictured license plate. Therefore, the computer system 5 may have the same functions as the recognition means 920, thus acting as its double whenever the mobile device 120 can't preform the recognition. Then, this information is stored in the player's 120 account as a playing number.

For instance, if the computational power of the player's 120 mobile phone 110 is insufficient to process the license plate data (captured as a picture or otherwise), the data are sent to the computer system 5 to be further processed. In addition, such approach protects playing numbers from forgery.

In another exemplary embodiment, when a vehicle license plate number is captured, the geolocation means 930 determine the user's (i.e. player's 120) geolocation, which is the linked (assigned) to the given playing number.

For instance, after the license plate number has been photographed and recognized, the geolocation means 930 of the mobile device 110 determine the coordinates of the place, where the given number has been captured, wherein the coordinates may include both geographic coordinates (i.e. latitude and longitude) and location markers, such as the neighborhood name, an address, the name of a nearby city object (e.g. fountain) or landscape object (e.g. pond).

A geolocation means 930 operates on the mobile device 120. Geolocation means 930 may be at least one of: GPS satellite navigation sensors; A-GPS satellite navigation sensors; GLONASS satellite navigation sensors; and base station signal sensors, wherein geolocation is determined using triangulation.

In another exemplary embodiment, the geolocation means 930 also utilizes data from electronic geographical maps (e.g. Google Maps), such as: city addresses; city architecture objects; landscape objects; historic landmarks; tourist attractions.

In another exemplary embodiment, the playing set may be augmented with new playing numbers by purchasing them in the in-game store, which may be accessed through the means for provision of playing numbers 940.

A means for provision of playing numbers 940 operates on the mobile device 120. Playing numbers may be selected and obtained through: a browser by connecting to the Internet; an application executed on the mobile device 110, via network connection to servers that support the game logic.

For instance, the player 120 may visit the game website via a browser using their mobile phone 110, where they may choose a playing number and buy it for their playing set.

In yet another exemplary embodiment, playing set may be augmented with playing numbers using the means for provision of playing numbers 940, i.e. by generating playing numbers based on a specific pre-defined principle.

In yet another exemplary embodiment, when a new playing number is generated, its geolocation is defined at least: randomly; or from a given set (which may also be randomized).

In an exemplary embodiment, in order to start the game, the playing sets of players 120 must contain more numbers than a given threshold.

In an exemplary embodiment, before the game starts, the computer system 5 levels the opponents.

In another exemplary embodiment, in order to level the opponents, the computer system 5 generates at least one playing number, so that newly generated numbers provide for full levelling of players' strength for the given game, wherein the number of newly generated numbers may be either pre-set or chosen dynamically based on the analysis of players' playing sets.

In yet another exemplary embodiment, in order to level the players, the computer system 5 removes at least two playing numbers from the playing set of each player, wherein the number of playing numbers to be removed may be either pre-set or chosen dynamically based on the analysis of players' playing sets.

Each playing number is attributed a strength value. Strength is a numerical value representing the difference of the given number from other numbers.

For instance, the playing number strength is a number ranging from 0 to 100, wherein a number with the strength of 0 is considered to be the weakest, while a number with the strength of 100 is considered to be the strongest.

In another example, the strength of a playing number is any integer that exceeds a given value, wherein the less multipliers can be extracted, the stronger this playing number is.

In an exemplary embodiment, the strength of newly generated playing numbers is defined at least: randomly (conforming to a pre-defined statistical law); or from a pre-defined set of values.

In another exemplary embodiment, the strength of newly generated playing numbers is defined, so that at least:
their strengths lie within a pre-defined range;
the aggregate strength of all generated playing numbers lies within a pre-defined range; or
their strengths conform to normal distribution.

In yet another exemplary embodiment, playing numbers are generated, so that the distribution of their strengths conforms normal distribution.

For example, playing numbers may be generated using the Monte Carlo method.

In yet another example, a weak number may be generated with 90% propability, a strong number with 9% probability, and a very strong number with 1% probability.

In another exemplary embodiment, after opponents have been matched, the strength of their respective playing sets is levelled by adding new playing numbers or removing some of them.

For instance, the players 120 start with nine playing numbers in their sets. To level the chances to win for players 120, three newly generated playing numbers are added to their respective playing sets. Generally, from none to nine numbers may be added, depending on the difference in average strength of players in question. Thus, both players 120 in this example would start the game having twelve numbers in their sets.

It should be obvious to a person skilled in the art that neither the size of starting playing sets nor the number of additional playing numbers affect the subject matter of the present technology.

In another example, the players 120 may start the game with nine numbers each (if their strength is initially equal), or with eighteen numbers each (if their strength has maximum difference).

Playing numbers may be removed from playing sets as well as added to them, in order to level the strengths of players.

In yet another example, the players 120 start the game having nine numbers in their respective playing sets, and then two numbers are removed from their playing sets to level their strengths. Thus, each player ends up having seven numbers in their sets.

In an exemplary embodiment, the player 120 and some other players 121 send new game requests via the computer network to the computer system 5, within a pre-set time period, using their mobile devices 110. Having received a new game request, the computer system 5 starts to match opponents for the player 120 from players 121 according to one of the pre-defined matching (selection) criteria. If opponents cannot be found according to the given criteria, the computer system 5 selects a virtual opponent 131.

In another exemplary embodiment, matching criteria are based on at least one of:
aggregate strength of players' playing sets and strength of playing numbers in these sets;
players' 120 geolocation data;
players' 120 previous game results;
players' 120 previous opponents 121.

In another exemplary embodiment, opponents are matched based on at least one of:
same average strength of their playing sets;
a pre-defined degree of similarity between average strengths of their playing numbers.

For instance, the player 120 has a playing set with the strength (the average strength of playing numbers in the set) of 80.5, so they will be matched with opponents 121, who have playing sets with the strength ranging from 78.0 to 82.0.

In yet another exemplary embodiment, the opponent is matched to the player based on their current geolocation.

In yet another exemplary embodiment, opponents are selected from players who are closer to the given player's current geolocation.

For instance, opponents 121 are matched to the player 120 if they are located within some pre-set range from the player 120.

In yet another exemplary embodiment, opponents are selected from the country that is not the same as the player's current geolocation.

In yet another exemplary embodiment, in case there are no players corresponding to the pre-defined criteria, the computer system 5 will generate (create) a virtual opponent 131 to match the player 120, which will correspond to the pre-defined criteria.

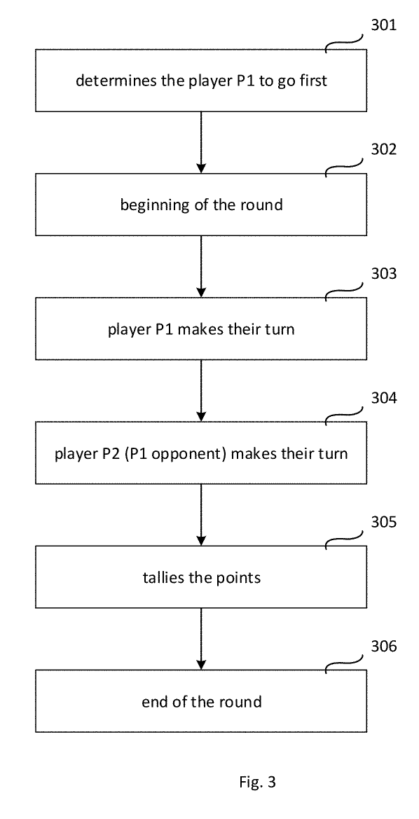

After the opponents to match the player 120 have been selected, the computer system 5 determines the player to go first 301, among all participating players (see FIG. 3). This may be either the player 120 or their opponent. After that, all preparatory steps are considered to be finished, and the game starts, which would last for at least one game round. The player P₁ selected to go first by the computer system 5 receives a notification to make the turn. The player P₁ makes their turn 303 by selecting one playing number from their playing set. Information regarding the selected playing number is sent to the computer system 5. The computer system 5 performs the following steps:
checking whether the player P₁'s information received from the mobile device 120 is correct;
in case the check is successful, sending information about the playing number selected by P₁ to P₂, along with the turn notification (alert);
otherwise, sending a notification (alert) to repeat the turn to P₁.

The player P₂ selects one playing number from their playing set. Information regarding the selected playing number is sent to the computer system 5. The computer system 5 checks whether the player P₂'s information received from the mobile device 120 is correct, and if not, sends a notification (alert) to repeat the turn to the player P₂.

Based on pre-defined rules and taking into account the information on correct playing numbers selected by the players, the computer system 5 tallies the points 305 gained by each player. Then, this information is sent to players P₁ and P₂ by the computer system 5. This process is repeated until all rounds in the game have been played. Then, the computer system 5 determines the winner based on the point totals that each player has gained over the entire series of game rounds. Points 609 that players gain at the end of the game are calculated based on pre-defined rules.

Information about the winner and point totals is sent to the players P₁ and P₂ by the computer system 5.

In an exemplary embodiment, the numbers player during the game are checked for validity on users' mobile devices 110, wherein after the game has ended, one or more playing numbers played during the current game, may be marked as suspicious. Then, such playing numbers have to be checked on other mobile devices, whether they conform to the rules of the game. If the majority of mobile devices confirm the validity of the given playing number, it is considered to be valid, otherwise it is considered to be invalid. After a required number of mobile devices have confirmed that the playing number in question is invalid, it is blocked.

In another exemplary embodiment, suspicious numbers are displayed to other players in the game interface for checking.

In an exemplary embodiment, the computer system 5 may be represented as:
a server;
a group of servers 10 connected into a network;
a cloud-based computer system (a cloud service).

In another exemplary embodiment, the computer system 5 comprises at least one game server and at least one database server.

In yet another exemplary embodiment, the computer network 16 is at least one of:

a LAN; a mobile 2G, 3G, or 4G network; a wireless Wi-Fi or Wi-Max network; a wireless Bluetooth network.

In an exemplary embodiment, the mobile device 110 is at least one of: a mobile phone; a smartphone; a PDA; a tablet; a laptop.

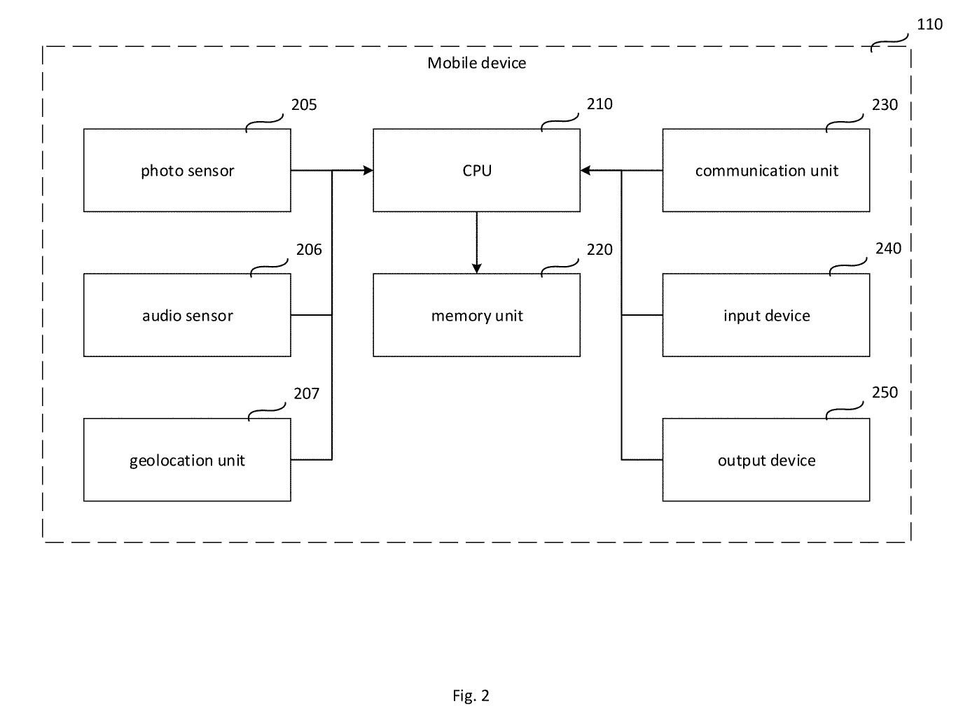

In an exemplary embodiment, the mobile device 110 (as shown in FIG. 2) comprises at least a CPU 210, a memory unit 220, a communication unit 230, an input device 240, an output device 250, a photo sensor 205 configured to take photographic pictures, an audio sensor 206 configured to make audio recordings, and a geolocation unit 207.

In another exemplary embodiment, in the mobile device 110, a photo sensor 205 and an audio sensor may be external.

In another exemplary embodiment, playing set generation means (see FIG. 9) may operate using the elements of the mobile device 110 (see FIG. 2) or utilize:
a means for capturing a vehicle license plate number 910 using at least a photo sensor 205, an audio sensor 206, or an input device 240;
a means for recognizing a vehicle license plate number 920, a means for generating playing numbers 950 using a CPU 210 and a memory unit 220;
a means for geolocation 930 using a geolocation unit 207;
a means for providing playing numbers 940 using a CPU 210, a memory unit 220 and an output device 250.

In an exemplary embodiment, the player to go first 302 is randomized in the beginning of a game round (see FIG. 3).

In another exemplary embodiment, the player to go first 302 is determined based on the average strength of the player's playing set.

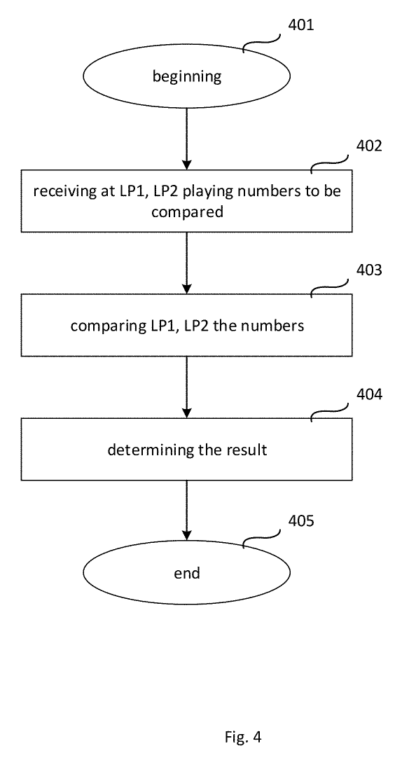

In an exemplary embodiment, the algorithm of playing number comparison comprises the following steps (see FIG. 4):
receiving at least two playing numbers to be compared 402;
comparing the numbers 403 symbol by symbol; and
determining the result 404 of comparison.

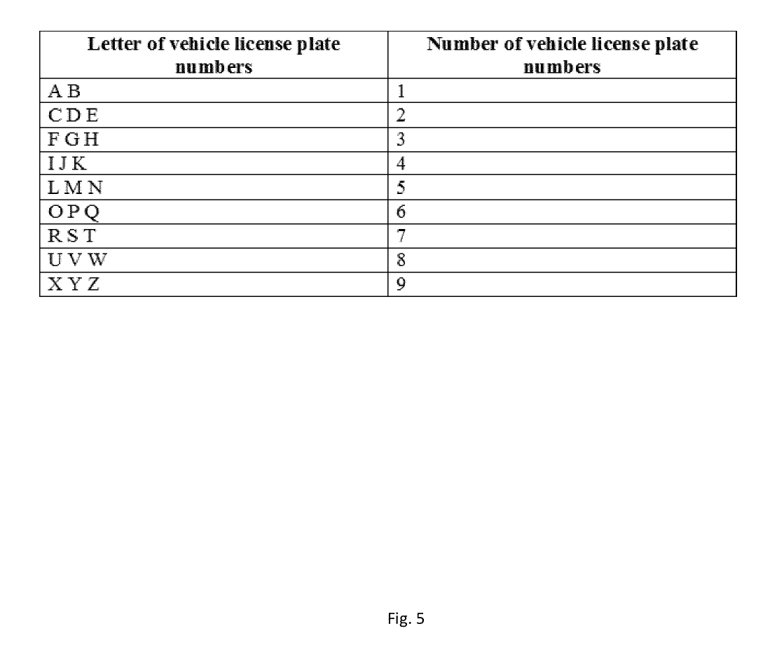

In an exemplary embodiment, the symbol-by-symbol comparison of playing numbers 403 is performed based on a substitution table containing correlations between each letter and number (see FIG. 5).

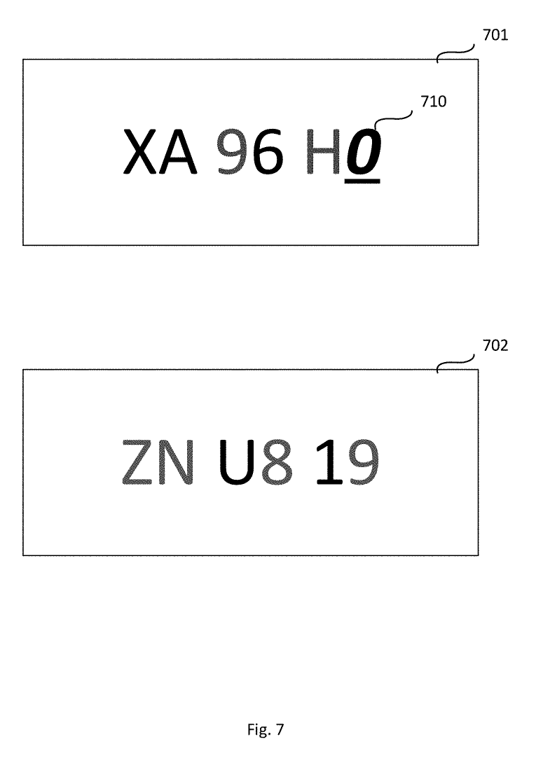

In another exemplary embodiment, when playing numbers 403 are compared symbol by symbol, in case the numbers have different number of symbols in them, missing symbols are substituted with a pre-defined value, e.g. zero (see 710 in FIG. 7).

In yet another exemplary embodiment, when playing numbers 403 are compared, the numbers 403 are parsed, wherein lexemes are being extracted to be further compared to each other.

In yet another exemplary embodiment, when playing numbers 403 are compared, hash sums are being compared that have been obtained through a convolution function from the playing numbers.

In yet another exemplary embodiment, when playing numbers 403 are compared, the lexemes extracted from the playing numbers are being compared. First, the numbers to be compared are tokenized, which provides a set of lexemes for each number.

Each lexeme is analyzed using a specialized method, which is specific for each lexeme type, and its processed data are generated. Then, the data obtained for both lexemes are compared to each other. The algorithm above may be represented mathematically in the following may:

$${L}_{{t}_{1}} = L ( {t}_{1} ) , \\ {L}_{{t}_{1}} = L ( {t}_{1} ) , \\ r = {\sum }_{i}^{{\{ L \}}_{{t}_{1}}} {\sum }_{j}^{{\{ L \}}_{{t}_{2}}} g ( {L}_{{t}_{1}} ( i ) , {L}_{{t}_{2}} ( j ) )$$

where

t₁ is a textual representation of the playing number #1,

t₂ is a textual representation of the playing number #2,

L is the playing number tokenization function,

lₜ_{₁} is the set of lexemes extracted from the playing number #1,

lₜ_{₂} is the set of lexemes extracted from the playing number #2,

{L}ₜ_{₁} is the number of lexemes extracted from the playing number #1,

{L}ₜ_{₂} is the number of lexemes extracted from the playing number #2,

Lₜ_{₁}(i) is the i-th lexeme from the set of lexemes extracted from the playing number #1,

Lₜ_{₂}(j) is the j-th lexeme from the set of lexemes extracted from the playing number #2,

g is the lexeme comparison function, wherein each lexeme may be transformed in advance by a method applied specifically to this particular lexeme type, i.e.

lᵢ=f(L(i)),

where f is the type-specific lexeme transformation function.

In an exemplary embodiment, any of a number in a given range (e.g. 0-50, 51-100, etc.), a text (e.g. “aa”, “texas”, etc.), or relations between lexemes (e.g. “the current lexeme is a number that is higher than the number represented by the previous lexeme”) represented as either a dynamically generated rule or an index (link) to a previously generated rule may be considered as a distinct lexeme type.

In another exemplary embodiment, any of a text recognition algorithm, or an algorithm that detects correlations between analyzed lexemes and values from pre-generated tables may be considered the lexeme transformation function.

In yet another exemplary embodiment, lexemes may be compared by either:
matching lexemes with values from pre-generated tables; or
comparing lexemes mathematically (including any string comparison rules known in the art).

For instance, lexemes extracted from playing numbers may be correlated with some gameplay elements, such as game core mechanics, e.g. playfield elements, skills, their interaction methods, etc. Comparison of the lexemes essentially means simulating (executing) interaction between gameplay elements, which may result in a string or a number describing that interaction, or any other gameplay element generated in the interaction.

In another example, the extracted lexemes may include individual symbols of a playing number, that may be correlated with special properties of gameplay elements (particularly, attacking and defending special moves) that may be triggered during the same turn or later.

In yet another example, the gameplay elements may include skills (special moves) that are triggered before the playing numbers are compared. Such skills “go off”, i.e. affect future comparison operations, against the opponent's number and weaken some of the symbols (either randomly or following pre-defined rules).

In an exemplary embodiment, when the result of comparison 404 of playing numbers is determined, the number containing more higher-valued symbols is considered to be the strongest one (i.e. one having maximum strength).

In another exemplary embodiment, when the result of comparison 404 of playing numbers is determined, the number containing more lower-valued symbols is considered to be the strongest one (i.e. one having maximum strength).

For instance, there are two playing numbers 701 and 702 at the input 402, that are to be compared, wherein both numbers have different lengths. These playing numbers are compared symbol by symbol. The first symbol of the playing number 701 is compared to the first symbol of the number 702. Since both these symbols are letters, they are compared against each other by their power, derived from their alphabetic order, where Z>A. In case a letter and a digit are compared, the substitution table is used (shown in FIG. 5), where each letter corresponds to a number for comparison purposes. Therefore, when U and 9 are compared, where U corresponds to 8, the result will be U<9.

In an exemplary embodiment, when comparing playing numbers, their geolocations are taken into account.

In another exemplary embodiment, when comparing playing numbers, strength of each number is adjusted based on the pre-set weight depending on the playing number geolocation.

In an exemplary embodiment, when the points 305 are tallied, the player gains F points for each higher-valued symbol.

In another exemplary embodiment, when the points 305 are tallied, the player gains F points for each higher-valued symbol, depending on the difference between the symbols that have been compared:

F˜sₚ_{₂}(i)−sₚ_{ᵢ}(i),

where i is the i-th symbol of a playing number, sₚ_{ᵢ} is a symbol from the player's playing number p₁, sₚ_{₂} is a symbol from the player's playing number p₂.

In yet another exemplary embodiment, when the points 305 are tallied, the player gains F points for each higher-valued symbol found during comparison 404, wherein the F value may be either pre-set or determined based on the player's rating or other criteria.

In an exemplary embodiment, the playing number strength is calculated by calculating the central tendency (e.g. arithmetic mean) of values of all symbols (letters and digits) that make up a playing number, wherein the higher the central tendency, the stronger the number.

In another exemplary embodiment, in order to calculate the central tendency of the symbols, each symbol is assigned a numerical value.

In an exemplary embodiment, a player has limited time to make their turn.

In an exemplary embodiment, before the turn is made, the player is notified of how much time is left.

In an exemplary improvement, points 609 gained by players at the end of the game may be calculated based on at least one of: result of the given game for the player (victory, loss, draw); player's rating; game type; playing number strength; the number of victories in a row; the score difference between the players; the number of real playing numbers played during the game; geolocations of numbers played during the game.

In an exemplary embodiment, the winner is determined based on geolocations of their strongest playing numbers.

In yet another exemplary embodiment, when determining the winner, areas or perimeters of shapes (e.g. polygons, circles, second-order curves, etc.) formed by the geolocations of numbers played by opponents are taken into account.

In yet another exemplary embodiment, when determining the winner, the distance between the geolocations of playing numbers played by the player is taken into account.

In yet another exemplary embodiment, when determining the winner, the distance between the geolocations of playing numbers played by players is taken into account.

In yet another exemplary embodiment, when determining the winner, the distance between the geolocations of playing numbers played by each player and the geolocations of players themselves is taken into account.

Playing set. In an exemplary embodiment, at the end of the game, one or more playing numbers from the defeated player's playing set may be added to the winner's playing, i.e. those playing numbers are effectively removed from the defeated player's playing set.

In another exemplary embodiment, the numbers selected by the winning player are selected automatically.

In another exemplary embodiment, the numbers selected by the winning player are selected by the winning player themselves.

In yet another exemplary embodiment, the numbers selected by the winning player are selected by the defeated player.

The present detailed description is not intended to be exhaustive or limiting to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes that fall within the true spirit of the disclosure. Features of various embodiments discussed herein may be used with other embodiments discussed herein. The foregoing description of the embodiments has been presented for the purposes of illustration and description.

1. A method for executing a computer game using vehicle license plate numbers, the method executable on a computing apparatus accessible by a plurality of user devices via a communication network, the method comprising:
receiving, by the computing apparatus, respective playing sets of one or more vehicle license plate images for at least two players prior to starting the computer game;
selecting from the at least two players, at least two matching opponents;
running at least one game round, the running including at least:
receiving from the at least two matching opponents a respective playing number from the respective playing set the playing numbers being a textual representation of a selected one of the one or more vehicle license plate images;
calculating a point-value for each one of the at least two matching opponents based on the respective playing number, the point-value being for the at least one game round;
aggregating for each opponent the point-value to a cumulative point-values for the opponent, the cumulative point-value being a total of the point-value for the at least one game round and all previously played rounds for the at least two opponents; and
determining the winner of the computer game by selecting a winning player with a highest value of the cumulative point-values.

2. The method of claim 1, wherein the selecting the at least two matching opponents comprises analyzing the plurality of users based on an average strength of the respective playing sets.

3. The method of claim 1, wherein a given playing set is generated, by the user device using a camera integrated into the user device, the playing set being generated by taking a photo of a license plate, the photo having been processed by the user device and stored as an image and corresponding letter-and-digit data as playing numbers in an account associated with a given user associated with the user device.

4. The method of claim 1, wherein the letter-and-digit data is used as the playing numbers and the image is used for verification of the playing numbers.

5. The method of claim 1, wherein, after the selecting from the at least two players, at least two matching, the method further comprises adjusting a strength of their respective playing sets by at least adding or removing playing numbers.

6. The method of claim 1, wherein the method further comprises generating a random order for the at least two opponents to play.

7. The method of claim 1, wherein the method further comprises assigning to each player a pre-determined time interval to play a turn and wherein the method further comprises, in response to the pre-determined time interval expiring without the user playing the turn, automatically playing the turn for the user.

8. The method of claim 1, wherein the calculating a point-value comprises comparing playing numbers of the at least two opponents by:
for the given playing number:
extracting at least one lexeme from each playing number based on lexical analysis; and
determining the total number of points gained by comparing all the extracted lexemes for each pair of playing numbers based on pre-set rules, wherein each rule define the number of points gained based on the analysis of each lexeme type.

9. The method of claim 1, wherein the calculating a point-value comprises comparing playing numbers of the at least two opponents by
for the given playing number having a plurality of symbols:
comparing the plurality of symbols, in a symbol by symbol manner, using their corresponding numerical values, to another plurality of symbols of a playing number of another user, wherein if one plurality of symbols is shorter than another plurality of symbols, the missing positions are filled with a pre-determined symbol for the purposes of the comparison; and
determining the number of points gained by each playing number based on the number of higher-valued and lower-valued symbols.

10. The method of claim 1, wherein the number of points gained by each player at the end of the game is determined using at least one of:
result of the given game for the player, the result being one of a victory, a loss, and a draw,
player's rating,
game type,
the strength of playing numbers in the given playing set,
the number of victories in a row,
the score difference between the players,
the number of real playing numbers played during the game.

11. The method of claim 9, wherein determining of points gained by players further comprises analyzing geolocation information.

12. The method of claim 10, the method further comprises, for a new round of the game, generating playing sets of participating players based on the results of the game round just finished.

13. A server for executing a computer game using vehicle license plate numbers, the server having a processor configured to:
receive, by the computing apparatus, respective playing sets of one or more vehicle license plate images for at least two players prior to starting the computer game;
select, from the at least two players, at least two matching opponents;
run at least one game round, the running including at least:
receiving from the at least two matching opponents a respective playing number from the respective playing set the playing numbers being a textual representation of a selected one of the one or more vehicle license plate images;
calculating a point-value for each one of the at least two matching opponents based on the respective playing number, the point-value being for the at least one game round;
aggregate for each opponent the point-value to a cumulative point-value for the opponent, the cumulative point-value being a total of the point-value for the at least one game round and all previously played rounds for the at least two opponents;
determine the winner of the computer game by selecting a winning player with a highest value of the cumulative point-values.

14. The server of claim 13, wherein to determine the winner, the processor is further configured to analyze geolocation information.

15. The server of claim 14, wherein to determine the winner, the processor is configured to take into account an area or a perimeter of a polygon formed by locations of the playing numbers played by the at least two opponents.

16. The server of claim 14, wherein the processor is further configured to take into account a distance between locations of the playing numbers played by the at least two opponents.

17. The server of claim 13, wherein the processor is further configured to store the geolocation information of the at least one player and to link the geolocation information to a corresponding playing number when a photo of the vehicle license plate number is taken by a camera.

18. The server of claim 14, wherein geolocation information is determined through at least one of: GPS, A-GPS satellite navigation systems, GLONASS system, and a base station triangulation.
